(19) United States
(12) Patent Application Publication
(10) Pub. No.: US 2005/0200144 A1
(43) Pub. Date: Sep. 15, 2005

(54) Bell lift

(76) Inventor: Frank Joe Bell, Madison, AL (US)

Correspondence Address: FRANK JOE BELL, 798 WALL TRIANA HWY, MADISON, AL, 35756, US

(21) Appl. No.: 10/920,978

(22) Filed: Aug. 18, 2004

Related U.S. Application Data
(60) Provisional application No. 60/497,856, filed on Aug. 26, 2003.

(51) Int. Cl. B66C 1/66

(52) U.S. Cl. 294/89

(57) ABSTRACT

A device designed to lift and move precast concrete pipes in a level manner. This device, once fabricated into one solid steel piece, will be able to lift a tremendous amount of weight, while allowing coworkers to maintain a safe distance.

### BACKGROUND OF THE INVENTION

1. Field of the Invention

The present invention relates to lifting and moving precast concrete pipes. More specifically, the device is partially inserted into the load hole of the concrete pipe where it can then be lifted level and safely by a crane or backhoe.

2. Description of the Related Art

In the industry of construction, lifting and moving large pieces of precast concrete pipes are a part of everyday business. Everyday, workers are putting themselves in harms way to move these enormous portions of concrete pipes that can weigh into the tons. Existing methods of pipe lifting/moving require large heavy apparatuses that cannot be lifted/used by one man.

### SUMMARY OF INVENTION

The invention is a device used to safely lift and transfer precast concrete pipes. With this device, a precast concrete pipe can be lifted level everytime eliminating the need for up to 2 workers saving time and lives.

The device works easily. The steel bar is inserted into the load hole of any given precast concrete pipe (FIG. 3 & FIG. 5). The D-Ring is then hooked onto a crane or backhoe (FIG. 2). As it is raised, the chain tightens and levels the steel bar inside the pipe, thus allowing the lift to be level.

It is my objective to have the device fabricated into one piece. This would eliminate the welding, which poses a safety issue due to strength questions and the 2 hammerlocks which also weaken the device. This would allow the device added strength to lift ?×1000's pounds of precast concrete pipes.

It is further an objective of this invention to allow precast concrete pipes to be lifted in a manner that would allow the helper to remain at a safe distance out of harms way.

It is another object of this device to eliminate time and effort of the current conventional methods of lifting concrete pipes. Current methods include heavy metal apparatuses that require heavy equipment just to prepare for the lift, whereas this device can fit in a lunchbox or even your back pocket.

### DESCRIPTION OF DRAWING AND PHOTOS

It is to be understood that the present invention encompasses any and all embodiments within the scope of its claims.

It is my intention that the final product be fabricated in one piece that would eliminate the need for the 2 hammerlocks and the welding.

Diagram

1. ⅝″ D-Ring dimensions=7 in×4.5 in

Connected To:

2. qty 2 hammerlocks 9/32″ Kuplock-T

Connected To:

3. qty 2 segments, 4′ in length, heavy duty steel chain 1.25″ link G80 alloy

One Link Welded on Each End of:

4. solid steel bar 10″×1″

FIG. 1

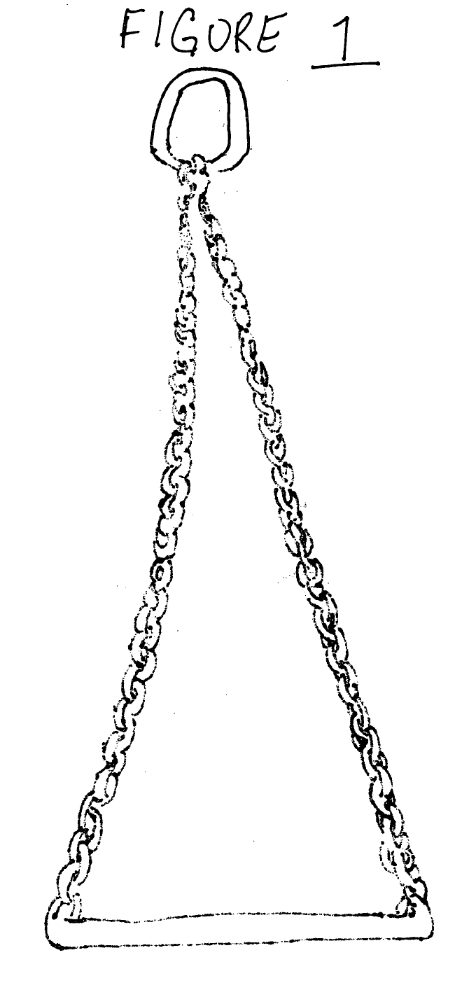

The device laying on the ground

FIG. 2

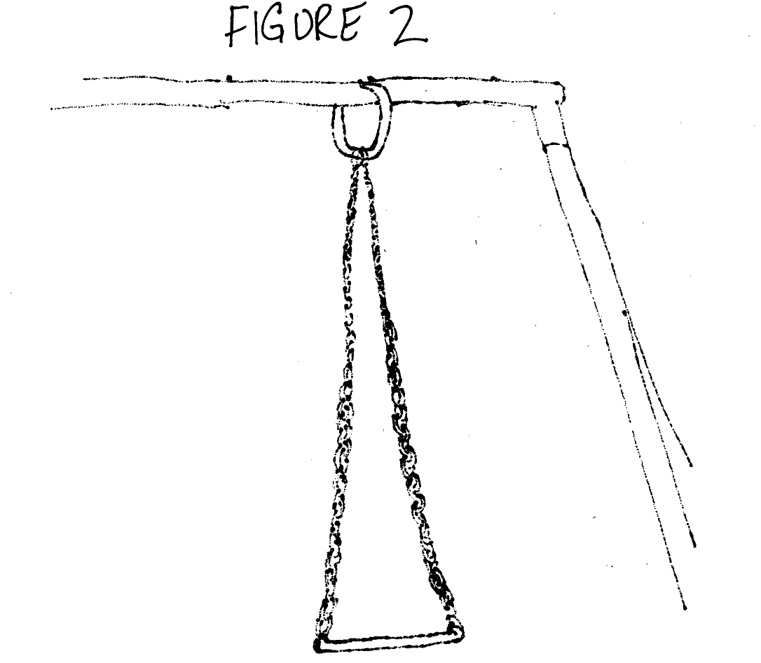

The device as it hangs

FIG. 3

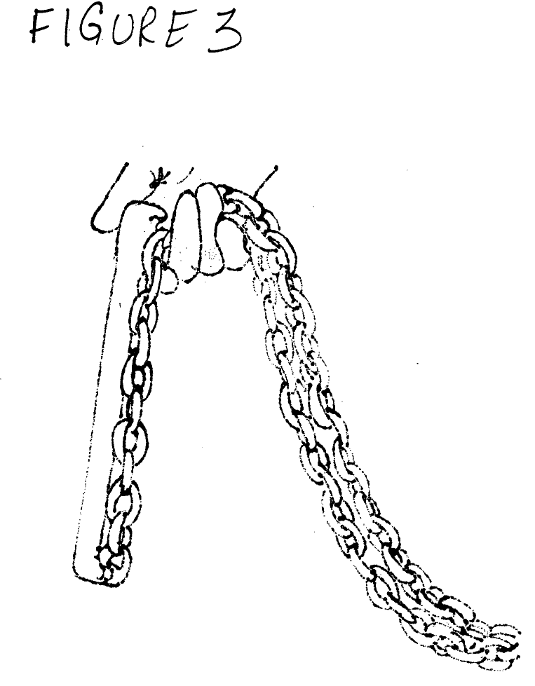

As the device would be held to insert into the load hole of a precast concrete pipe

FIG. 4

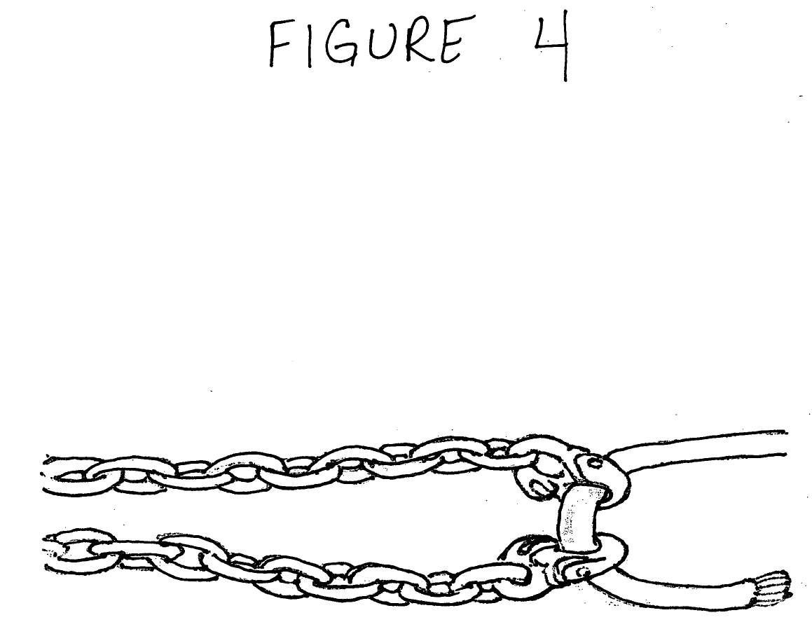

A view of the hammerlocks connecting the d-ring to the chain segments

FIG. 5

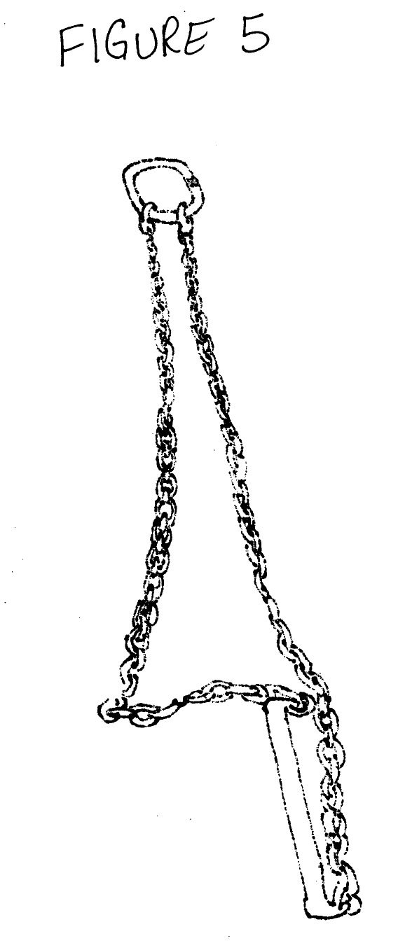

Another view as to how it would be inserted

1. a concrete pipe lifting device comprised of:
quantity item
1 ⅝″ D-Ring 7 in×4.5 in
2 9/32 Kuplock-T hammerlocks
2 4′ segments of heavy duty steel chain 1.25″ link G80 Alloy
1 10″×1″ solid steel bar

2. The lifting device is made entirely of steel.

3. The device can be inserted by one person and lifted in a matter of seconds.

4. The device allows for more safety when lifting precast concrete pipes.
